(19) United States
(12) Patent Application Publication
(10) Pub. No.: US 2003/0075064 A1
(43) Pub. Date: Apr. 24, 2003

(54) Cleaning-cloth roller for cleaning devices

(76) Inventor: Torsten Schmutz, Bobingen (DE)

Correspondence Address: OSTROLENK FABER GERB & SOFFEN, 1180 AVENUE OF THE AMERICAS, NEW YORK, NY, 100368403

(21) Appl. No.: 10/181,544

(22) PCT Filed: Apr. 5, 2001
(86) PCT No.: PCT/EP01/03857

(30) Foreign Application Priority Data
Apr. 8, 2000 (DE) 100 18 425.1

(51) Int. Cl. B41F 35/00

(52) U.S. Cl. 101/425

(57) ABSTRACT

Dirty-cloth takeup roller for cleaning devices Dirty-cloth takeup roller for cleaning-cloth devices for cleaning running printing material webs or cylindrical rotating bodies in a printing machine or another machine in a print shop. From a longitudinal slot in a sleeve (4), on which the cloth can be wound up, a drive lip (10) for guiding the cloth in the direction of rotation can be extended radially counter to a spring force by an inner body (14) that can be inserted into the sleeve. The drive lip (10) gives the cloth roll an inner diameter which is greater than the outer diameter (12) of the sleeve (4). As a result, the cloth roll can easily be pulled off the sleeve (4) when the drive lip (10) is moved back into the sleeve (4).

The invention relates to a dirty-cloth takeup roller for cleaning devices for cleaning running printing material webs or cylindrical rotating bodies in a printing machine or another machine in a print shop, according to the preamble of claim 1.

U.S. Pat. No. 4,344,361 discloses a cleaning device for cleaning printing machine cylinders, having a washing cloth which can be rewound from a clean-cloth takeup roller to a dirty-cloth takeup roller that is driven step by step and, on the path from one roller to the other roller, can be pressed by a pressing device against the cylindrical surface to be cleaned of a cylinder to be cleaned, which rotates. The rollers are spindles of small diameter. In the document, a blanket cylinder is named as the printing machine cylinder.

Cylindrical rotating bodies which can be cleaned in accordance with the invention are, in printing machines, in particular plate cylinders, impression cylinders, damping-unit rolls and guide rolls. The expression “cylinder” in this description therefore signifies generally rotating cylindrical bodies, irrespective of whether they are referred to as cylinders, rolls or rollers by those skilled in the art. The invention is also suitable for cleaning cylindrical rotating bodies in print-shop machines which are arranged after the printing machine, for example cooling rolls after a drying oven, glue application machines, coating machines, laminating machines, folding machines and so on.

The invention can be used both as a driven clean-cloth takeup roller and as a driven dirty-cloth takeup roller. However, the invention has particular advantages as a dirty-cloth takeup roller. The cloth is normally referred to as a washing cloth since, in the moist state, it is placed against the cylinder to be cleaned and either contains moisture already on the clean-cloth takeup roller or is moistened by a moistening device on the path from one roller to the other. The dirty cloth of the dirty-cloth takeup roller must be removed from the cloth roller at the end of the winding operation in order to be cleaned or to be thrown away as a disposable product. In order to clean or to throw away the dirty cloth, it must be removed from the dirty-cloth takeup roller, which is normally done by means of an unwinding process. In this case, it is usual for the worker in the print shop to place the dirty-cloth takeup roller on the floor and unroll it there. This not only takes up time and space but also produces environmental contamination, since the printing-ink dust falls from the dirty cloth onto the floor and is also swirled in the air.

In order to save unrolling the dirty cloth to be thrown away from its cloth roller, a cloth roller has already been proposed which can be pulled out axially from the dirty-cloth roll if a rod or a spike has previously been pulled out axially. The rod can be inserted into a longitudinal groove in the outer circumference of the cloth roller for the purpose of connecting a starting section of the dirty cloth in a rotationally fixed manner to the cloth roller. This proposal has the disadvantage that both the rod and also subsequently the cloth roller can be pulled out from the dirty cloth wound up smoothly, that is to say under tensile stress, only with difficulty and with the expenditure of a great deal of effort.

The invention is intended to achieve the object of constructing a cloth roller in such a way that during the winding of a cloth, it drives the cloth starting section in the direction of rotation of the roller securely and without slip, and that after the cloth has been wound up, the cloth roller can be pulled out of the cloth roll with little force in the roller longitudinal direction.

According to the invention, this object is achieved by the characterizing features of claim 1.

The cloth roller according to the invention has the advantage that it drives a cloth in the takeup direction of rotation without slip, but that subsequently the cloth roller (spindle) can be pulled axially out of the cloth roll in a simple way, quickly and with little force. The drive element projects beyond the outer diameter of the sleeve, so that the inner roll diameter of the cloth is greater than the outer diameter of the sleeve. If the drive element is then moved back into the sleeve, the sleeve, together with all the parts located in it, that is to say the entire cloth roller, can easily be removed axially without special resistance from the larger diameter of the cloth roll.

As a result, the soiled cloth can be disposed of or taken into a washing facility, without needing to be unwound from the cloth roller. Dirt particles remain caught in the cloth roll and do not pass into the environment, so that no contamination of the environment is produced.

Further features of the invention are contained in the subclaims.

The invention will be described in the following text using a preferred embodiment as an example. In the drawings:

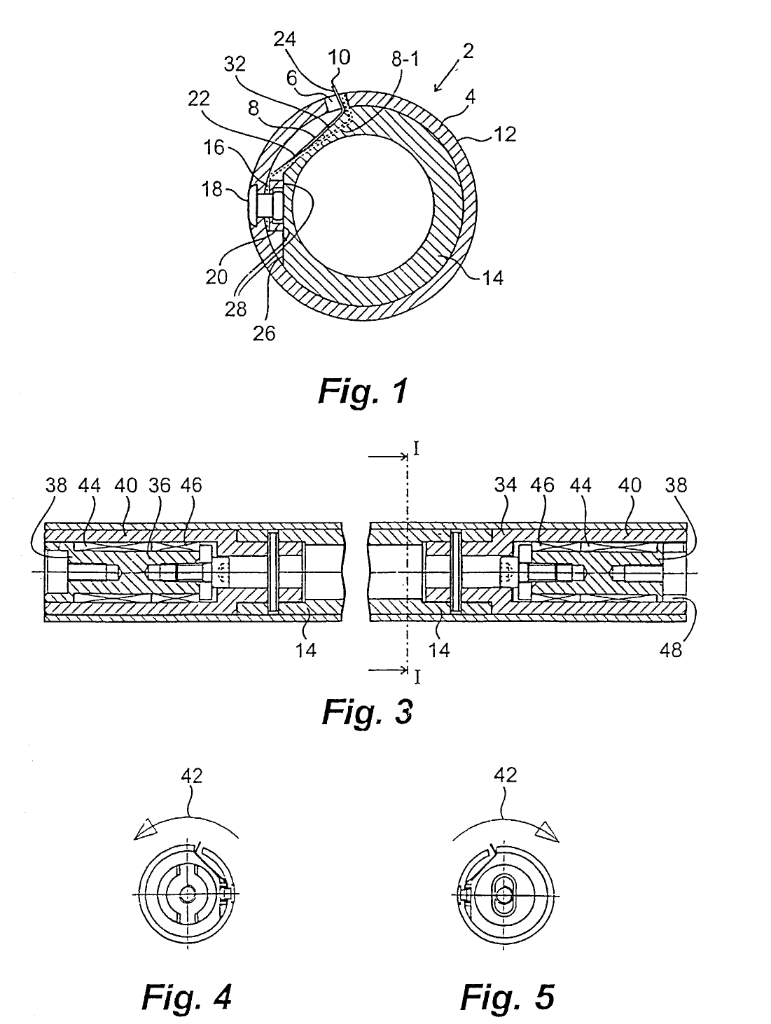

FIG. 1 shows an end view of a cloth roller according to the invention for a printing-machine cylinder cleaning device,

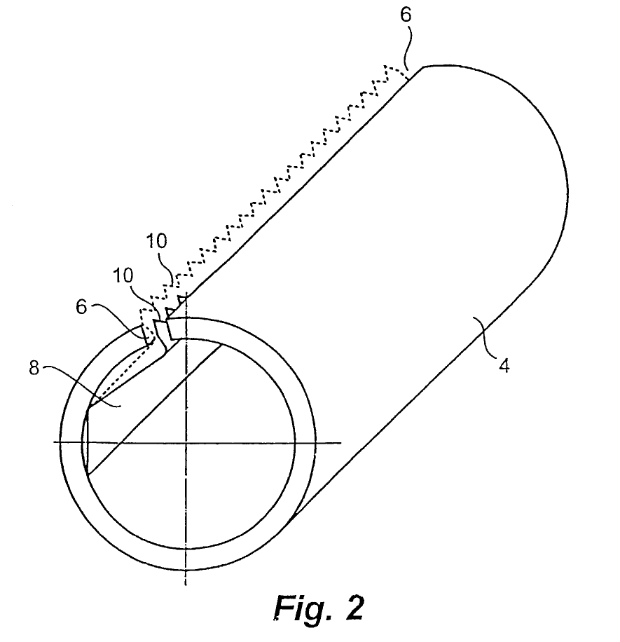

FIG. 2 shows a perspective view of an outer sleeve of the cloth roller of FIG. 1,

FIG. 3 shows an axial section through the cloth roller of FIG. 1 together with further parts,

FIG. 4 shows a side view of the cloth roller of FIG. 3 as viewed from the right,

FIG. 5 shows a side view of the roller from FIG. 3, as viewed from the left,

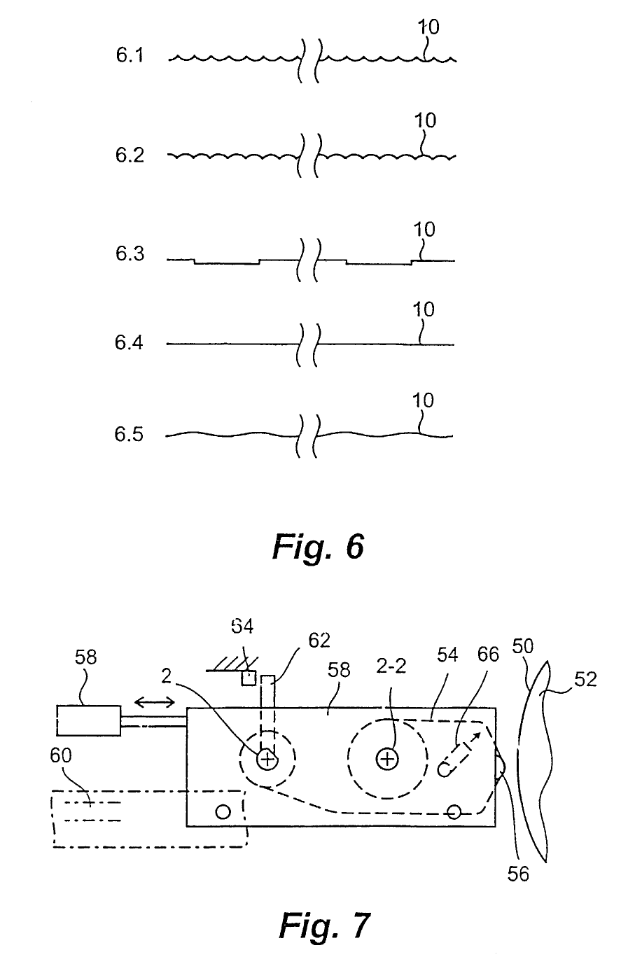

FIG. 6 shows five different further variants 6.1, 6.2, 6.3, 6.4 and 6.5 of a drive lip of the cloth roller,

FIG. 7 shows, in schematic form, a side view of a cleaning device having at least one cloth roller according to the invention for a cloth for cleaning printing-machine cylinders.

In the following text, the cloth roller according to the invention will be described as a dirty-cloth takeup roller (spindle) that can be driven step by step in the direction of rotation in order to takeup a washing cloth in a cleaning device for cleaning a printing-machine cylinder, the washing cloth being wound onto it during this step-by-step rotation.

As FIG. 1 shows, the cloth roller 2 has an outer sleeve 4, on which a washing cloth can be wound up. The sleeve 4 has at least one longitudinal slot 6, which extends over a part length, which corresponds approximately to the width of the washing cloth, or preferably over the entire length of the sleeve, corresponding to the drawings.

Fixed to the sleeve 4 is a drive element 8 in the form of a spring steel plate unwound in opposite directions at two points, which has a drive lip 10 which extends radially within the sleeve outer diameter 12, in the longitudinal direction of the longitudinal slot 6, into a cloth release position, which is shown by dotted lines 8-1 in FIG. 1 and, counter to the spring force of the drive element, can be moved outward through the longitudinal slot 6, beyond the sleeve outer diameter 12, into a cloth drive position, which is shown by continuous lines in FIG. 1, to drive the washing cloth in one or the other roller direction of rotation. The length of the drive lip 10 is of approximately the same size as the width of the washing cloth, in order that the washing cloth can be deflected radially outward beyond the sleeve outer diameter 12 by the drive lip as the cloth is wound up onto the sleeve 4. As a result, the cloth roll is given an inner diameter which is greater than the outer diameter of the sleeve 4.

An inner body 14 in the form of a tube or rod can be displaced within the sleeve 4, relative to the latter, in the sleeve longitudinal direction. Depending on its longitudinal position, the inner body 14 forces the drive lip 10 outward, counter to the spring force of the resiliently flexible drive element 8, into the cloth drive position beyond the sleeve outer diameter 12, as shown by continuous lines in FIG. 1, or releases the drive lip 10, so that it is moved back inward by the spring force into the cloth release position within the sleeve outer diameter 12, which is shown by dotted lines 8-1 in FIG. 1. When the drive lip 10 is in its release position within the sleeve outer diameter 12, the cloth roll can easily be pulled off the sleeve 4, since the inner diameter of the cloth roll is then greater than the outer diameter of the sleeve 4.

The drive element 8 is arranged inside the sleeve 4 and, at its end portion 16 angled away from the drive lip 10 is clamped in by rivets 18 (or screws) between the inner circumferential wall of the sleeve 4 and a guide strip 20 and, as a result, is fixed to the sleeve 4.

The drive element 8, consisting of spring steel plate has a spring area 22 which, between its angled points, stretches through the sleeve 4, for example in the manner of a chord, and at whose one end the fixing end portion 16 is angled over and at whose other end the end section 24, which forms the drive lip 10, is angled over.

The inner body 14, designed as a tube, has on its outer circumference a coupling surface 26 which deviates from the inner circle of the sleeve 4, for example extending in the manner of a chord, which bears on a coupling face 28 of the guide strip 20 that is opposed to it and aimed into the interior of the sleeve 4 and is positioned by said guide strip 20, so that the inner body 14 relative to the sleeve 4 is kept in a specific rotational position relative to the sleeve 4 and is rotationally fixedly connected to the sleeve. The coupling surface 26 of the inner body 14, together with the coupling surfaces 28 of the guide strip 20, forms a plug-in coupling which is engaged by inserting the inner body 14 axially into the sleeve 4 and is disengaged when these two parts are removed axially from each other. The coupling surfaces 26 and 28 preferably extend over the entire length of the inner body 14 and the sleeve 4.

The coupling surface 26 of the inner body 14 is adjoined, preferably at an angle which is greater than 90 and less than 180, by a chord-like run-on surface 32, which is formed on the inner body 14 and, when the inner body 14 is inserted into the sleeve, runs onto the chord-like spring area 22 of the drive element 8 and, as a result, forces the drive lip 10 of the latter from the cloth release position, shown by dotted lines in FIG. 1, into the cloth drive position, shown by continuous lines. According to embodiments that are not shown, the coupling surface 26 and the run-on surface 32 are arranged at 180, that is to say flush, with each other or at an angle of less than 90 to each other.

According to FIGS. 3,4 and 5, the inner body 14 is provided with a bearing means 34 and 36 at its two ends for the purpose of rotatable mounting in a carrier. The two bearing means 34 and 36 can be identical or different.

According to the embodiment shown in FIGS. 3, 4 and 5, the bearing means 34 and/or 36, at least at one end of the inner body 14, is formed by a freewheel drive, by means of which a drive torque can be transmitted from a bearing pin 38 to the inner body 14 only in one direction of rotation, while the bearing pin 38 can be rotated freely in the opposite direction of rotation relative to the inner body 14. In FIGS. 4 and 5, the freely rotatable direction of rotation of the inner body 14 relative to the bearing pin 38 is indicated by arrows 42.

The two bearing means 34 and 36 can also be substantially identical, if only one of them has or forms a freewheel drive. Both bearing means 34 and 36 preferably have a bearing hub 40, which is rotationally fixedly connected to the inner body 14 and has outer circumferential surfaces which are flush with the outer circumferential surfaces of the inner body 14, in that they have a circular outer circumference at the same circumferential points as the inner body 14, a chord-like flat coupling surface 28 and a chord-like flat run-on surface 32. Between the bearing pin 38 and the associated bearing hub 40 there are bearing elements 46 and, at least in the case of one of the two bearing means 34 or 36, also freewheel drive elements 44. At the end, the bearing pin 38 has a diagonal slot 48, in which a driver or other drive element can engage in a rotationally fixed manner.

The bearing hubs 40 are axial extensions of the inner body 14 and therefore likewise form “inner bodies” which, in addition to the inner body 14 or instead of this inner body 14, can be provided with the coupling surface 26 and the run-on surface 32 and have their function.

The drive lip 10 is intended to be designed in such a way that it can press into a cloth in order to drive the latter in the direction of rotation of the cloth roller 2. For this purpose, the drive lip 10 can have any desired form suitable for that purpose, for example the pointed saw-tooth shape shown in FIG. 2 or one of the form shown in FIG. 6, for example the corrugated form with upper corrugated tips, shown at 6.1 in FIG. 6, or the corrugated form rounded at the top shown at 6.2, or the rectangular corrugated form shown at 6.3, or the rectilinear form shown at 6.4, or the corrugated shape rounded at the top and the bottom shown at 6.5.

FIG. 7 shows, schematically in side view, a “washing bar” for cleaning the cylindrical surface 50 of a printing-machine cylinder 52 by means of a washing cloth 54, which is pulled off a clean-cloth takeup roller 2-2 over a pressing element 56 by a dirty-cloth takeup roller 2 of the type described above according to the invention. The clean-cloth takeup roller 2.2 can be of the same type as the dirty-cloth takeup roller 2. They are rotatably mounted in side plates of the washing bar 58, which can be moved forward and backward relative to the cylinder 52 in a guide 60 by means of an actuating drive 58, in order to press the washing cloth 54 against the cylinder surface 50 by means of the pressing element 56 or distance it from said cylinder surface 50. During each reverse movement away from the cylinder 52 (or during each forward movement), a drive element 62, which is rotationally fixedly connected to the bearing pin 38 by means of its diagonal slot 48, is prevented from moving by a stop 64, as a result of which it rotates the dirty-cloth takeup roller 2 by a corresponding rotational angle and, as a result, moves the washing cloth 54 onward by one step. During movement of the washing bar 54 in the opposite direction, the drive element 62 is not hindered by the stop 64, but is rotated back by a spring, not shown, in the freewheel direction of rotation of the bearing means 34 and/or 36 formed as a freewheel. On its movement path from the clean-cloth takeup roller 2-2 to the pressing element 56, the washing cloth 54 can be moistened with water or another liquid by a moistening device 66, as in the prior art.

1. A dirty-cloth takeup roller for cleaning devices for cleaning running printing material webs or cylindrical rotating bodies in a printing machine or another machine in a print shop, characterized in that an outer sleeve (4) is provided, on which the relevant cloth can be wound up and which has at least one longitudinal slot (6), in that a drive element (8) is fixed to the sleeve (4), and has a drive lip (10) which extends radially within the sleeve outer diameter (12), in the longitudinal direction of the longitudinal slot, into a cloth release position over a length which is at least approximately as great as the width of the winding cloth, and which can be moved outward counter to a spring force and through the longitudinal slot (6) beyond the sleeve outer diameter (12) into a cloth drive position in order to drive the cloth in the direction of rotation of the sleeve and in order to deflect the cloth outward over the sleeve outer diameter (12) as the cloth is wound up onto the sleeve (4), in that an inner body (14, 40) is provided, which can be displaced within the sleeve (4), relative to the latter, in the sleeve longitudinal direction and, depending on its longitudinal position, forces the drive lip (10) outward counter to the spring force into the cloth drive position or releases it, so that it is moved back inward by the spring force into the cloth release position.

2. The dirty-cloth takeup roller as claimed in claim 1, characterized in that the drive element (8) is a spring steel plate, which produces the aforementioned spring force.

3. The dirty-cloth takeup roller as claimed in claim 1 or 2, characterized in that the drive element (8) is arranged within the sleeve (4), at least with respect to its resiliently flexible spring area producing the spring force.

4. The dirty-cloth takeup roller as claimed in one of the preceding claims, characterized in that the drive lip (10) is a material section of the drive element (10).

5. The dirty-cloth takeup roller as claimed in claim 3 or 4, characterized in that the drive element (8) has a section (22) extending transversely through the interior of the sleeve (4).

6. The dirty-cloth takeup roller as claimed in one of claim 5, characterized in that the drive lip (10) is provided on a spring steel plate end section (24) which is angled over and adjoins a section (22) extending transversely.

7. The dirty-cloth takeup roller as claimed in one of the preceding claims, characterized in that the drive lip (10) is toothed.

8. The dirty-cloth takeup roller as claimed in one of the preceding claims, characterized in that the inner body (14, 40) can be inserted into the sleeve (4) in the sleeve longitudinal direction and can be pulled out of the sleeve, in that a coupling means (20, 26, 28) for the rotationally fixed but detachable connection between the sleeve (4) and the inner body (14, 40) inserted into it is provided, and in that the inner body (14, 40) has two ends, which have bearing means (34, 36) for the rotatable mounting of the inner body (14, 40) in a carrier.

9. The dirty-cloth takeup roller as claimed in claim 8, characterized in that the coupling means (20, 26, 28) has a plug-in coupling with coupling surfaces (26, 28) which are engaged with each other by the inner body (14, 40) being inserted into the sleeve (4) and, when the inner body (14, 40) is removed from the sleeve (4) come out of engagement.

10. The dirty-cloth takeup roller as claimed in claim 8 or 9, characterized in that at at least one end of the inner body (14, 40), a freewheel drive (34, 36) is provided, by means of which a rotational drive torque can be transmitted from a bearing element (38) to the inner body (14, 40) only in one direction of rotation, but the bearing element (38) can be rotated freely relative to the inner body (14, 40) in the opposite direction of rotation.
